(19) United States
(12) Patent Application Publication
(10) Pub. No.: US 2001/0023900 A1
(43) Pub. Date: Sep. 27, 2001

(54) Apparatus for metering, mixing, and spraying component liquids

(76) Inventors: Patrick H. Stewart, Danville, IL (US); Arman V. Melikyan, Danville, IL (US)

Correspondence Address: Alan B. Samlan, Knechtel, Demeur & Samlan, Suite 1410, 222 S. Riverside Plaza, Chicago, IL, 60606, US

(21) Appl. No.: 09/810,363

(22) Filed: Mar. 16, 2001

Related U.S. Application Data
(63) Continuation-in-part of application No. 09/415,856, filed on Oct. 8, 1999, now abandoned.

(51) Int. Cl. B05B 9/04

(52) U.S. Cl. 239/304; 239/373; 239/355; 239/353; 239/360; 239/363

(57) ABSTRACT

An apparatus for metering, mixing, and spraying liquids is provided. The apparatus includes a first storage chamber and a second storage chamber connected to one another via channels that permit the free flow of air between the first storage chamber and the second storage chamber so that the pressure in each of the chambers is equal. The channels are fitted with liquid flow limiting members for preventing the flow of liquid from the first storage chamber to the second storage chamber and from the second storage chamber to the first storage chamber. Liquid delivery tubes associated with each storage chamber permit liquid from the storage chamber to flow into a mixing chamber. In the mixing chamber, the two liquids combine to form a solution. The concentration of that solution is variably adjustable by means of a flow restriction member associated with the first storage chamber. There is a storage area for receiving the liquids in the storage chambers if the device is tipped onto its side or while moving the device through various angles during its operation.

### RELATED APPLICATION

This application is a continuation-in-part of application Ser. No. 09/415,856 filed on Oct. 8, 1999, still pending.

### I. TECHNICAL FIELD OF THE INVENTION

The present invention relates to spraying systems, and more particularly, to a spraying system that enables the variable concentration mixture of liquids and delivery of that mixture by means of a hand held device under constant pressure conditions.

### II. BACKGROUND OF THE INVENTION

Many liquid solutions must be mixed just prior to their application. For instance, cleaning chemicals, consumer fertilizers and insecticides, and paints are often mixed with water prior to their application. Other solutions must be mixed just prior to application to prevent unwanted and untimely chemical reactions. For instance, many epoxies require mixing just prior to their use.

It is not uncommon for these solutions to be mixed manually. Manual mixing raises safety issues when the user is exposed to concentrated chemicals while mixing. Manual mixing also results in increased costs due to waste from inaccurate measurement and over-mixing and lost time during the mixing process.

Components are also blended in stationary metering devices and then transferred to spray devices. These systems address safety issues and cost issues due to inaccurate measuring but do not address the efficiency issues involving lost time. In fact, these costs can increase since the mixing is accomplished away from the point of application, thereby increasing labor costs.

Accordingly, attempts have been made to develop devices in which the components to a solution are mixed in a delivery system. Over the years, several devices have been offered for the mixing and delivery of liquid solutions. For example, U.S. Pat. No. 644,237 discloses a kerosene sprayer in which a pressure pump housed to first reservoir is placed in a second reservoir, the first reservoir is designed to hold kerosene and the second reservoir is designed to hold an ancillary liquid. Both liquids are drawn up by a pump, mixed, and expelled. A further example is seen in U.S. Pat. No. 3,767,705 which discloses an aerosol can having two chambers, the chambers each containing a chemical component which, when mixed, are expelled. A further example is seen in U.S. Pat. No. 5,711,457 which discloses yet another device having multiple chambers for the mixing and delivery of liquids. A principal shortcoming of the foregoing prior art is the liquid dispensed from these inventions is so done at a fixed concentration. The devices teach no method for altering the concentration of the expelled liquid within the devices themselves.

Other advancements in the prior art include the ability to variably change the concentration of the mixed liquids. Examples of such prior art are seen in U.S. Pat. Nos. 1,948,401, 4,355,739, 5,152,461, 5,385,270, and 5,411,176. However, these devices do not permit the expulsion of a liquid mixture under constant pressure conditions. Each of these inventions require the user to manually pressurize the liquid mixture for expulsion. This is usually done through a trigger mechanism in which the user must constantly engage the trigger to activate a manual pump that draws liquid from the chambers into a mixing chamber, and then, from the mixing chamber, expel the liquid to the atmosphere. Once the pumping action ceases, pressure in the devices dissipate.

Hand held portable applicators have other problems unique unto themselves. For example, the chemicals must be properly mixed in the proper proportions in the hand held device itself. The mixing cannot be done in separate, stationary tanks. The chemicals must be maintained separately in separate chambers or compartments and there must be safeguards to minimize the possibility of the chemicals contaminating each other. This separation of chemicals must be maintained even while the applicator is moved through positions and angles to apply the mixed solution. This presents different problems than those associated with stationary chemical storage tanks.

The prior art also fails to teach the ability to or desirability of variably mixing the concentration of liquids and dispensing them in a constant flow under pressurize conditions. The principal reasons appear to be that, until the present invention, if a system is pressurized, liquid is then drawn up from each chamber at a constant rate, thereby preventing the variable control of concentration levels. Conversely, in the prior art permitting variable concentration levels, constant pressure could not be applied since the adjustment of concentration would upset the pressure balance in the system.

The present invention addresses these problems in a unit that enables the concentration of a liquid mixture to be adjusted, the liquid mixture then being delivered in a constant flow under pressurized conditions.

### III. OBJECTS OF THE INVENTION

It is an object of the present invention to provide a dispensing system for liquids that enables the constant flow of a liquid mixture under pressurized conditions while at the same time enabling the user to adjust the concentration level of the liquid mixture. It is a further object of the invention to provide such a system in a device having a first storage chamber and a second storage chamber connected to one another via two channels, wherein the channels permit the free flow of air between the first and second storage chambers, the channels further having a liquid flow limiting means that minimizes the likelihood of contamination between the two liquids stored in the first and second storage chambers. The advantage is that the two liquids remain separated even while the hand held applicator is moved through various positions while spraying the mixed liquid.

A related object is to provide a hand held mixing and spraying device having a mixing chamber for accepting liquid from the first storage chamber and the second storage chamber, means to variably restrict the flow of liquid from the first storage chamber into the mixing chamber, and means for expelling the liquid from the mixing chamber to the atmosphere.

It is a further object of the invention to provide such a system that is economical and easy to use.

### IV. SUMMARY OF THE INVENTION

The above objects of the invention are provided for in a two component liquid metering, mixing, and spraying apparatus. According to the invention, the apparatus includes a first storage chamber and a second storage chamber. The first storage chamber and second storage chamber are connected to one another via at least one and preferably two channels. The channels permit the free flow of air between the first storage chamber and the second storage chamber. The channels are fitted with a liquid flow limiting member, the liquid flow limiting member prevents the flow of liquid between the first storage chamber and the second storage chamber but do not impede the free flow of air between the first storage chamber and the second storage chamber. In the preferred embodiment, one channel permits air flow from the first storage chamber to the second storage chamber and a second channel permits air flow from the second storage chamber to the first storage chamber. Also provided are means to apply pressure to the first storage chamber. The geometry of the applicator device also minimizes the chance of cross contamination of the liquids if the applicator device is place on its side or during the application process.

Also provided are liquid delivery tubes associated with each storage chamber, the liquid delivery tubes permit liquid from the storage chamber to flow into a mixing chamber. In the mixing chamber, the two liquids combine to form a solution. The concentration of that solution is variably adjustable by means of a flow restriction member associated with the first storage chamber. The flow restriction member can be adjusted to vary the flow of liquid from the first storage chamber into the mixing chamber, thus altering the concentration of the mixture.

The mixing chamber has an expulsion member that enables the mixed solution to be expelled into the atmosphere. The mixing chamber is also fitted with a sealing member that controls the expulsion of the mixed liquid. The restriction member is preferably a piston that has a closed position and an open position. The piston is selectively moved from the open position to the closed position via a trigger mechanism. When the trigger mechanism is engaged, the piston is moved to the open position and the pressurized solution is expelled from the mixing chamber until the trigger is disengaged.

### V. BRIEF DESCRIPTION OF THE DRAWINGS

FIG. 1 is a side perspective view of the inventive device.

FIG. 2 is side cross sectional view of the device.

FIG. 3 is a top view of the device.

FIG. 4 is an enlarged view of the underside of the valve body.

FIG. 5 is a perspective view of the top portion of the inventive device with the valve body, nozzle and trigger mechanism removed.

FIG. 6 is a top view of the valve body of FIG. 5 showing the air channels between the chambers.

FIG. 7 is an enlarged cross sectional view with portions removed of one of the chambers with an umbrella valve therein.

FIG. 8 is an enlarged perspective view of the metering screw.

FIG. 9 is a perspective view of the valve body.

FIG. 10 is a cross section view of the valve body, mixing chamber and nozzle in the open position.

FIG. 11 is a cross section view of the valve body, mixing chamber and nozzle in the closed position.

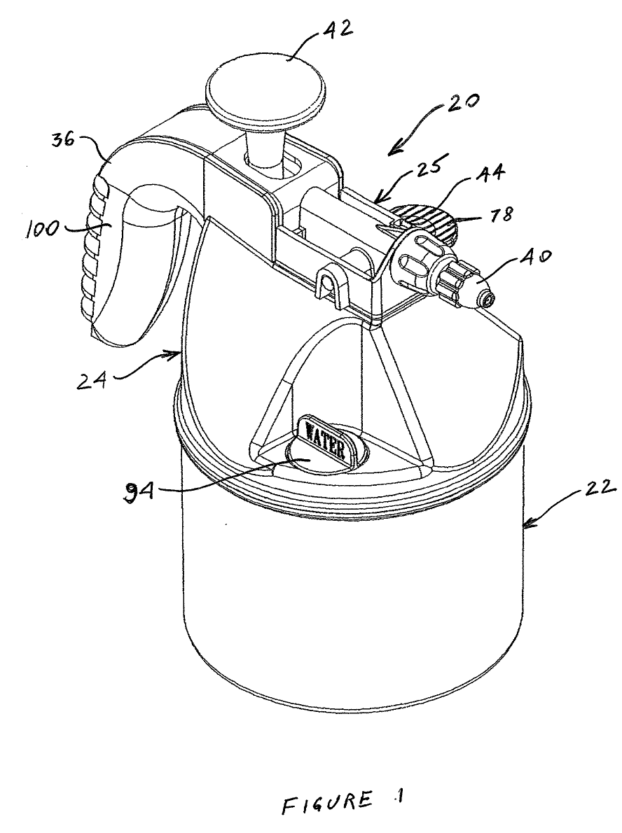

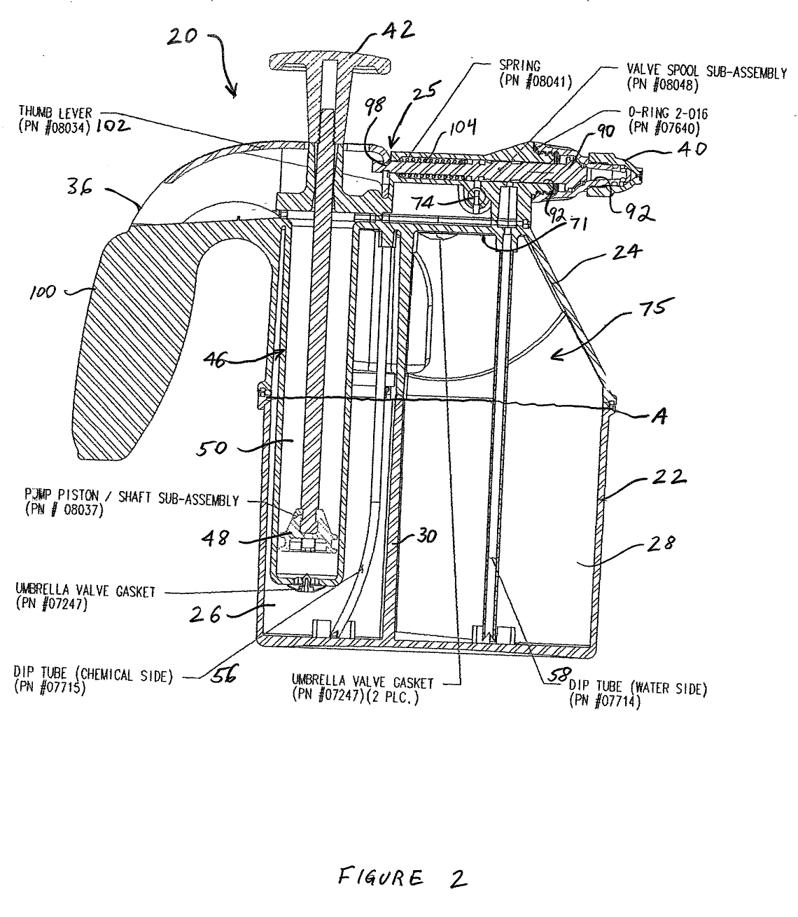

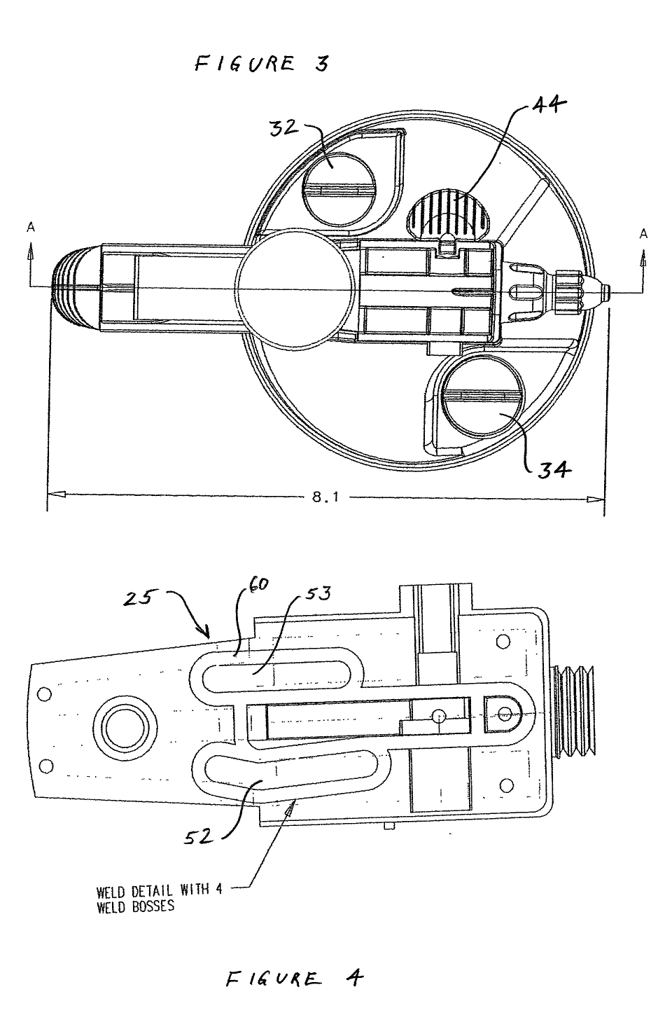

### VI. DESCRIPTION OF THE PREFERRED EMBODIMENT

The description of the preferred embodiment is described with reference to a portable, hand held device. The teachings can also be used for a device that has the storage chambers separated from the applicator. As long as pressurized air introduced into one of the chambers can freely flow between the chambers and flow of one component liquid can be variably adjusted as it flows into a mixing chamber, the device will work. Also, the description of the preferred embodiment is illustrated with reference to a two chamber device. The principles of the invention will also work equally well with three or more chambered devices. As long as pressure introduced into one of the chambers can freely flow into all chambers so that they are of equal pressure, and the flow of liquid from at least one of these storage chambers into the mixing chamber can be variably adjusted, the teachings of the invention can be utilized.

Turning to FIGS. 1 and 2, device 20 is depicted. Device 20 has a chamber body 22, top portion 24, and valve body 25. Housed within chamber body 22 are first storage chamber 26 and second storage chamber 28. First storage chamber 26 and second storage chamber 28 are divided by chamber dividing wall 30. First storage chamber and second storage chamber are vessels that hold separate liquid components destined for later mixing. First storage chamber 26 is filled through first storage chamber fill hole 32 and second storage chamber is filled through second storage chamber fill hole 34. Top portion 24 further includes handle 36, spray nozzle 40, pump handle 42, and metering screw handle 44, all of which will be explained in more detail below.

Turning to FIG. 2, a side cross sectional view of device 20 is depicted. As can be seen, pump 46 extends vertically through valve body 25, top portion 24 and into chamber body 22. In the preferred embodiment, pump 46 is a standard hand pump wherein pressure is increased within the device by manipulation of pump handle 42 wherein raising pump handle 42 elevates pump plunger 48 within pump cavity 50. Through operation of air intake valves (not shown) air is drawn into pump cavity 50. Depressing pump handle 42 lowers pump plunger 48 down within pump cavity 50, thereby compressing the air within pump cavity 50. While the preferred embodiment is directed to a manual pump, other pumps such as an electric pump, either battery or plug-in type, will also work. So long as sustainable pressure is applied to the system, the pump mechanism is not critical to the working of the apparatus.

Pressure from pump 46 is introduced directly into first storage chamber 26. Preferably the pressure is in the range of one to twenty-five pounds per square inch. This is a low pressure system specifically designed for hand operated portable use. The pressurized air within first storage chamber 26 moves freely from first storage chamber 26 to second storage chamber 28 via a first channel 52 (see FIG. 6). A second channel 53 permits the pressurized air in second storage chamber 28 to move freely back into first storage chamber 26. The chambers 52 and 53 are defined by side walls 60 formed in the top portion 24 and the valve body 25. Free flow of air between the two storage chambers in either direction enables constant pressure to exist throughout the system, thereby providing the constant flow of component liquids necessary for the overall action of device 20.

First channels 52 and second channel 53 each further include a liquid flow limiting member 54 and 55, respectively. Liquid flow limiting members 54, 55 prevent liquid from transferring between first storage chamber 26 to second storage chamber 28 and from transferring between second storage chamber 28 to first storage chamber 26. The liquid flow limiting members help reduce contamination between the two chambers. Liquid flow limiting members 54 and 55 are preferably one way valves, for example, umbrella valves. In order to allow for air flow between the two storage chambers in either direction, there is need for a first channel 52 and a second channel 53. The one way valves 54, 55 restrict the liquid flow in one direction that is opposite the direction of the air flow. There is an air vent hole 55 in passageway 52 above and in fluid communication with chamber 26. Similarly, there is an air vent hole 59 above and in fluid communication with chamber 28.

As seen in FIG. 7, there is the umbrella valve 54 mounted in a valve stem hole 57 adjacent to the air vent hole 59. This allows air from chamber 26 to flow into chamber 28 if the pressure in chamber 26 is greater than the pressure in chamber 28. The umbrella valve 54 keeps the liquid in chamber 28 from flowing back into the passageway 52. There is an identical arrangement in passageway 53 wherein the valve 55 restrains liquid in chamber 26 from entering the passageway 53. The valve 55 covers air vent hole 61 that is in fluid communication with the chamber 26. There is another air vent hole 63 in passageway 53. Air vent 63 is above and in fluid communication with chamber 28. Thus, if the air pressure is greater in chamber 28, the air will flow from chamber 28 through the air vents 63 and 61 into the chamber 26. To keep the pressure equalized between the two chambers, the air flow throughout the system must be unimpeded. Therefore, any configuration that impedes the flow of liquid between the two or more storage chambers, but allows the free flow of air between the chambers, is suitable.

Extending from valve body 25, through top portion 24 in an essentially vertical downward direction into chamber body 22 are first liquid delivery tube 56 and second liquid delivery tube 58. First liquid delivery tube 56 extends from top portion 24 into first storage chamber 26 and second liquid delivery tube 58 extends from top portion 24 into second storage chamber 28. First liquid delivery tube and second liquid delivery tube are hollow members which have a free end terminating in their respective storage chambers. The opposite ends of first liquid delivery tube and second liquid delivery tube are in fluid communication with and deliver their respective liquids to a mixing chamber 72.

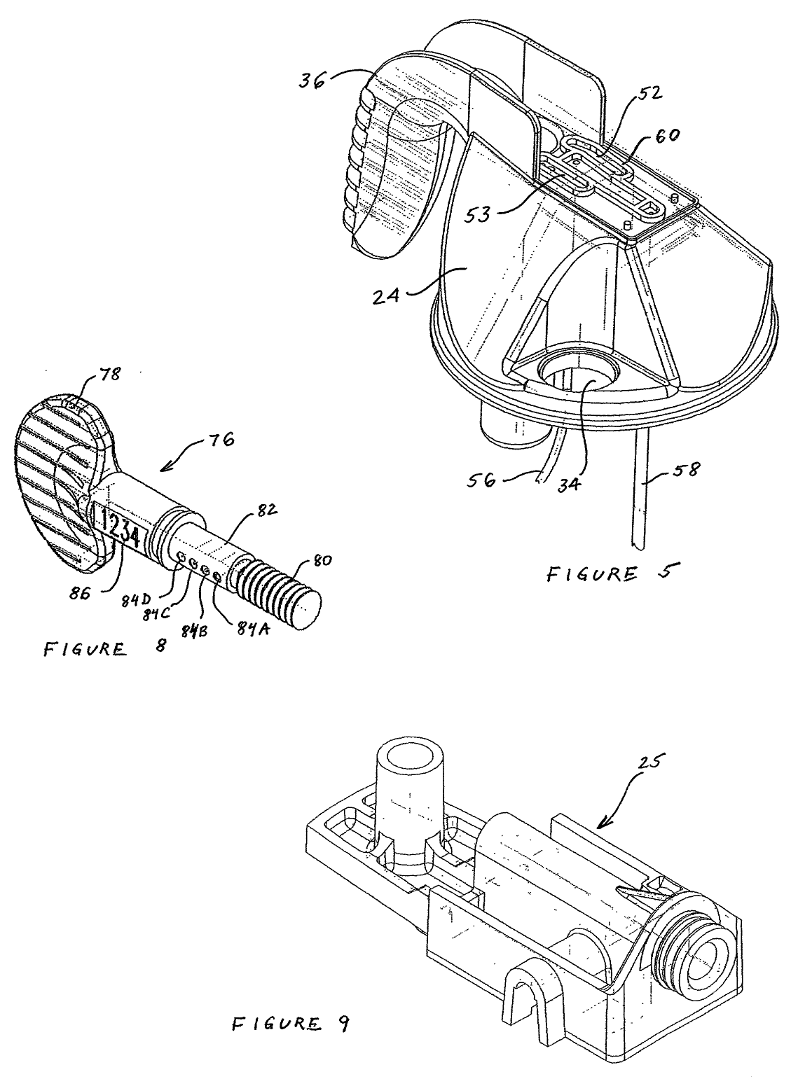

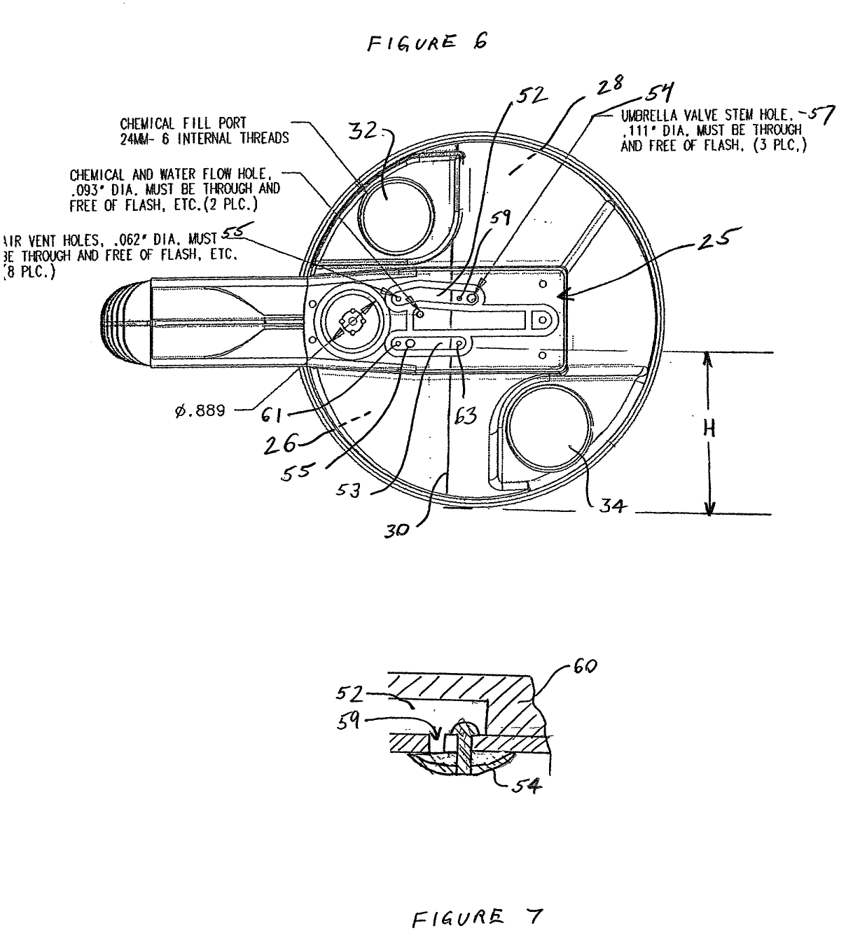

Found along the course of first liquid delivery tube 56 is found metering device 74. Preferably located in valve body 25, metering device 74 allows the user to adjust the flow of liquid traveling from first storage chamber 26 to the mixing chamber 72, thereby altering the concentration of the solution in mixing chamber 72. In the preferred embodiment, metering device 74 comprises metering screw 76 (see FIG. 8). Metering screw 76 further includes metering screw twist handle 78, thread members 80, and flow orifice section 82. Flow orifice section 82 further comprises a plurality of restriction orifices extending through the diameter of flow orifice section 82. In the representative example illustrated in FIG. 8, there are four orifices, 84A, 84B, 84C, and 84D. Each of the orifices is a different diameter which, in turn, permit varying rates of liquid flow through metering device 74 depending on the orifice 84A, 84B, 84C or 84D which is aligned with first liquid delivery tube 56. Optionally, metering screw twist handle 78 may include indices 86 to help insure that the user is aware of which orifice 84 is aligned with first liquid delivery tube 56. After passing through one of the orifices 84A, 84B, 84C, or 84D, liquid continues to travel through first liquid delivery tube 56 and is deposited into mixing chamber 72. Other metering systems may also be employed, such as a wheel having openings of various diameters. Alternate systems that restrict flow are contemplated as suitable for device 20 so long as they restrict flow and do not permit air and liquid leaks. Liquid flows unrestricted from second storage chamber 28 through second liquid delivery tube 58 into mixing chamber 72.

Since the system is pressurized equally in both first storage chamber 26 and second storage chamber 28, both storage chambers supply pressurized liquid into mixing chamber 72. So long as pressure is maintained in the system, the solution as mixed in mixing chamber 72 will expel from mixing chamber 72 through spray nozzle 40 with a force dependent upon the pressure of the overall system. As the design maintains the pressure in the two chambers equally, as the liquid is expelled, the pressure in both chambers decreases equally.

A user optimally fills the first storage chamber 26 and the second storage chamber 28 to fill line A. Fill line A is roughly equal to the junction of top portion 24 and chamber body 22. Top portion 24 is an essentially hollow member contiguous with chamber body 22, including an extension portion of chamber dividing wall 30. The space between fill line A and the upper limit 71 of top portion 24 serves as a sink 75 to house compressed air introduced by pump 46. The compressed air causes the pressure necessary to force the liquid in first storage chamber 26 and second storage chamber 28 through first liquid delivery tube 56 and second liquid delivery tube 58 into mixing chamber 72.

Sink 75 also creates a space between the liquids in the storage chambers 26 and 28 and the channels 52 and 53. The dividing wall 30 divides the sink 75 into two areas in the top portion 24 forming a top portion above the first storage chamber 26 and a top portion above the second storage chamber 28. The sink 75 is large enough so that if the device 20 is tipped onto its side, the liquid in chambers 26 and 28 remain below the air vent holes in either channels 52 or 53. Assuming that FIG. 6 is a side view of the device 20 when it is tipped onto its side, height H is the maximum height of the liquids in storage chambers 26 and 28. The height H is slightly below the limiting members 54 and 55 and the air vents 61 and 63. If the device 20 was tipped over onto its other side, the same relationship of the liquid level and the air vents 52 and 55 will be found. The positioning of the air vents and limiting members in conjunction with the volume of the sink 75, minimizes the risk of liquid entering channels 52, 53 either through the air vent holes or aspirating through limiting members 54 and 55.

The size and geometry of the sink 75 and the location of the air vent holes and limiting members 54 and 55 operate in conjunction with each other to minimize the possibility of the two liquids contamination each other. When the device is moved to orient the nozzle in the proper direction to spray the mixed chemical, the device does not allow the liquids in the storage chambers 26, 28 to flow into the air vent holes or past the limiting members 54, 55. The normal angle of motion is generally between 90 degrees up and down from the horizontal. This means that the nozzle 40 points straight up or straight down to apply the mixed solution. It is in these two extreme positions that there is the greatest likelihood of cross contamination of the liquids. Thus the size of the sink 75 and location of the air vent holes must be properly positioned to accommodate these two extreme positions. This design minimizes the possibility of cross contamination of the liquids in storage chambers 26, 28 when device 20 is in an off horizontal position regardless if the off horizontal position is due to the device 20 being tipped onto its side or moved through various positions in use. Even during spraying, when the air pressure is constantly being equalized between the two chambers, the geometry and placement of the vent holes prevent aspiration of liquid through the vent holes.

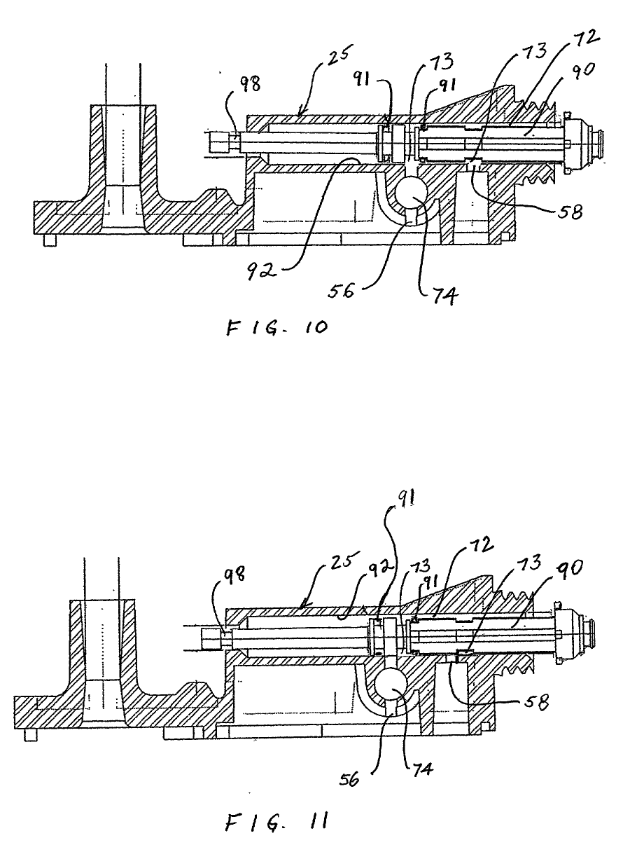

The solution in mixing chamber 72 is expelled through spray nozzle 40 by manipulation of piston 90. This is most clearly illustrated in FIGS. 10 and 11. The mixing chamber 72 is illustrated and defined by the area surrounding the piston 90 and the expulsion tube 92. Piston 90 is mounted for reciprocating sliding movement within expulsion tube 92. When in the closed position, a forward end of piston 90 seals closed the discharge end of expulsion tube 92. As seen in FIG. 11 the piston 90 also closes the discharge ends of first delivery tube 56 and second delivery tube 58 thereby inhibiting the release of the solution in mixing chamber 72. As seen in FIG. 11, upon retraction of piston 90, a pair of recesses 73 in the piston 90 move over the tops of the delivery tubes 56 and 58. This opens the exit ends of discharge ends of delivery tubes 56 and 58. The liquids in the delivery tubes 56 and 58 enter the mixing chamber 72. The discharge end of expulsion tube 92 is opened and the solution in mixing chamber 72 expels through nozzle 40. The piston 90 may also have o-rings 91 installed about portions of its circumference to aid in sealing the chamber 72 and further inhibiting either of the liquids from leaking into the chamber when the device is the off position. Piston 90 can be adapted to operate in any number of ways. For example, a tab on piston 90, which extends to the exterior of device 20, may be employed, or a trigger device located on device 20 near handle 36 could also be employed. The mechanism for selectively moving piston 90 from an opened position to a closed position is not critical.

In the preferred embodiment, a thumb lever 102 on the handle 36 joins piston 90 at connection 98. The thumb lever 102 is pivotally mounted to top portion 24 near pump handle 42. The user places a hand around handle 36, and pushes down on the thumb lever 102. The pushing action causes the thumb lever to pivot, pulling the piston 90 towards the handle 36. This action, in turn causes piston 90 to move to an open position with respect to the expulsion tube 92, allowing the solution to expel from nozzle 40. Releasing the pushing pressure on thumb lever 102 allows spring 104 to push the piston 90 back to a closed position, terminating the expulsion of solution.

The construction of device 20 can be made in any of the standard molding processes. The only requirement is that it is liquid and airtight so that constant pressure can be maintained within the system and liquid does not leak from the system. Top portion 24 may be conjoined with chamber body 22 by a plastic welding process, a twist lock mechanism, or a snap lock mechanism.

In use, the user fills first storage chamber 26 via first storage chamber fill hole 32 and second storage chamber 28 via second storage chamber fill hole 34. Once the storage chambers are filled with the desired liquids, the fill holes are sealed with fill hole caps 94.

Pressure is then introduced into the system by manipulation of pump 46. When the desired level of pressure is introduced into the system, the user manipulates metering screw twist handle 74 to the desired concentration setting as indicated by indices 86. In doing so, the user has, internally, aligned one of the orifices 84A-84D with first liquid delivery tube 56. Liquid from first storage chamber and second storage chamber then flows through first liquid delivery tube 56 and second liquid delivery tube 58, respectively, into mixing chamber 72. The liquid from the first storage chamber 26 passes through the metering device and the liquid from the second storage chamber 28 flows unrestricted.

In mixing chamber 72, the component liquids are mixed into a solution through an impingement type reaction. The user grasps the handle 36 and presses on the thumb lever 102 as described above causing movement of piston 90 in expulsion tube 92 to an open position. The solution in mixing chamber 72 is then expelled through nozzle 40 until such time as the thumb lever 102 is released and the piston 90 is manipulated into a closed position within expulsion tube 92.

In an alternate embodiment, more than two storage chambers are employed in the device. For a non-limiting example, a four chamber device could be employed. In this embodiment, pressure would be introduced into one of the storage chambers. Through channels that interconnect each storage chamber, pressure can be distributed throughout the system in the same manner as in the two chambered system described above. Liquid flow restricting devices must be employed between each chamber. Further, each chamber must have a liquid delivery tube extending from it into the mixing chamber. In the alternate embodiment, at least one of the storage chambers must have a metering device for restricting the flow of liquid from that chamber into the mixing chamber.

While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

We claim:

1. A hand held portable device for dispensing liquids comprising:
a chamber body;
a first storage chamber in the chamber body having a first liquid delivery tube;
a second storage chamber in the chamber body having a second liquid delivery tube;
means for applying a positive air pressure to either the first storage chamber or the second storage chamber;
a first channel that enables air to freely flow from the first storage chamber to the second storage chamber when the air pressure in the first storage chamber is greater then the air pressure in the second storage chamber;
a second channel that enables air to freely flow from the second storage chamber to the first storage chamber when the air pressure in the second storage chamber is greater than the air pressure in the first storage chamber whereby the air pressure in the first and second storage chambers is maintained at the same level;
means associated with the second channel for preventing liquid from flowing from the first storage chamber to the second storage chamber;
means associated with the first channel for preventing liquid from flowing from the second storage chamber to the first storage chamber;
a mixing chamber adapted to accept liquid from the first storage chamber and the second storage chamber, the liquid flowing from the first storage chamber to the mixing chamber through the first liquid delivery tube and from the second storage chamber to the mixing chamber through the second liquid delivery tube; and
means for expelling liquid from the mixing chamber.

2. The device of claim 1 wherein the means for applying the positive air pressure is a hand pump.

3. The device of claim 1 wherein the means associated with the first and second channels for preventing liquid from flowing to the other chamber is an umbrella valve mounted in each of the first channel and the second channel.

4. The device of claim 1 and further comprising means for restricting liquid flow to the mixing chamber from either the first or the second storage chamber.

5. The device of claim 4 wherein the means for restricting liquid flow is an adjustable metering device.

6. The device of claim 5 wherein the adjustable metering device comprises a metering screw, the metering screw further comprising a plurality of different diameter orifices through which liquid is permitted to flow.

7. The device of claim 1 wherein the means for expelling liquids further comprises a piston, the piston having an open position and a closed position, the piston sealing flow from the mixing chamber through a liquid expulsion member when in the closed position.

8. The device of claim 7 wherein the piston is selectively moved from the closed position to the open position via a trigger mechanism, the trigger mechanism enabling expulsion of liquid from the mixing chamber through a liquid expulsion member.

9. The device of claim 1 wherein the first and second storage chambers are vertically disposed adjacent to each other and the first storage chamber is comprised of an upper first storage portion and a lower first storage portion, and the second storage chamber is comprised of an upper second storage portion and a lower second storage portion, the lower first and second storage portions designed to receive a maximum quantity of liquid.

10. The device of claim 9 wherein the first channel and second channel are mounted in the upper first storage portion and upper second storage portion respectively.

11. The device of claim 10 wherein the liquid in the first and second lower storage portions is below the first and second channels when the device is oriented in a horizontal plane and the lower storage portions receive the maximum quantities of liquid for which they are designed.

12. The device of claim 11 wherein the upper first storage portion and the upper second storage portion are dimensioned to receive the liquid from the lower first storage chamber and the lower second storage chamber respectively when the device is rotated up to ninety degrees about the horizontal plane so that the liquid remains below the first and second channels.

13. A hand held portable device for metering the mixture of two liquids and then spraying the mixture of two liquids comprising:
a first storage chamber further comprising a first means for introducing liquids, a first means for withdrawing liquids, and means for pressurizing the first storage chamber;
a second storage chamber further comprising a second means for introducing liquid and a second means for withdrawing liquid;
a first channel between the first storage chamber and the second storage chamber, the channel enabling the free flow of air between the first storage chamber and the second storage chamber when the pressure in the first storage chamber is greater than the pressure in the second storage chamber, the channel further including along its length a valve that restricts the flow of liquid between the second storage chamber and the first storage chamber;
a second channel between the second chamber and the first chamber, the second channel enabling the free flow of air between the second storage chamber and the first storage chamber when the pressure in the second storage chamber is greater than the pressure in the first storage chamber, the channel further including along its length a valve that restricts the flow of liquid between the first storage chamber and the second storage chamber;
a mixing chamber further comprising a first opening for accepting liquids from the first storage chamber delivered via the first means for withdrawing liquids, a second opening for accepting liquids from the second storage chamber delivered via the second means for withdrawing liquids, and a third opening for expelling liquids, the third opening having a mixed liquid expulsion member extending outwardly from it;
a metering device that enables restriction of liquid flow from the first storage chamber to the mixing chamber through the first means for withdrawing liquid; and,
an expulsion control member for selectively expelling liquid from the mixing chamber, the expulsion control member comprising a piston, the piston having an open position and a closed position, the piston being selectively moved from an open position to a closed position through use of a trigger mechanism.

14. The metering member of claim 13 wherein the metering device adjustably restricts the liquid flow from the first storage chamber to the mixing chamber and comprises a metering screw having a plurality of orifices of different diameter, each of the plurality of orifices permitting a different volume of flow from the first storage chamber to the mixing chamber.

15. A hand held portable device for metering the mixture of liquids and then spraying the mixture of liquids comprising:
a first storage chamber further comprising a first means for introducing liquids, a first means for withdrawing liquids, and means for pressurizing the first storage chamber;
at least one additional storage chamber, each at least one additional storage chamber further comprising means for introducing liquid and second means for withdrawing liquid;
a first channel between the first storage chamber and the at least one additional storage chamber, the first channel enabling the free flow of air between the first storage chamber and the at least one additional storage chamber, the first channel further including along its length a valve between the first storage chamber and the at least one additional storage chamber that limits the flow of liquid between the at least one additional storage chamber and the first storage chamber;
a second channel between the at least one additional storage chamber and the first storage chamber, the second channel enabling the free flow of air between the at least one additional storage chamber and the first storage chamber, the second channel further including along its length a valve between the at least one additional storage chamber and the first storage chamber that limits the flow of liquid between the first storage chamber and the at least one additional storage chamber;
a mixing chamber further comprising a first opening for accepting liquids from the first storage chamber delivered via the first means for withdrawing liquids, an opening for accepting liquids from each of the at least one additional storage chamber delivered via the second means for withdrawing liquids, and a third opening for expelling liquids, the third opening having a mixed liquid expulsion member extending outwardly from it;
a metering device that enables restriction of liquid flow from the first storage chamber to the mixing chamber through the means for withdrawing liquid; and,
an expulsion control member for selectively expelling liquid from the mixing chamber, the expulsion control member comprising a piston, the piston having an open position and a closed position, the piston being selectively moved from an open position to a closed position through use of a trigger mechanism.

16. The device of claim 15 wherein the metering device enables variable restriction of liquid flow from the storage chamber to the mixing chamber.

17. The device of claim 16 wherein the metering device comprises a metering screw, the metering screw further including a plurality of orifices of different diameter, each of the plurality of orifices permitting a different volume of flow from the first storage chamber to the mixing chamber.

18. A hand held portable device for dispensing liquids comprising:
a housing comprising a front, rear and two opposite sides,
a first storage chamber having a first upper portion and a first lower portion, the first lower portion adapted to receive a first liquid when the device is in an upright position with the first upper portion being devoid of the first liquid;
a first liquid delivery tube mounted in the first storage chamber;
a second storage chamber having a second upper portion and a second lower portion, the second lower portion adapted to receive a second liquid when the device is in the upright position with the second upper portion being devoid of the second liquid;
a second liquid delivery tube mounted in the second storage chamber;
a first channel having an air inlet in the first storage chamber for allowing air from the first storage chamber to enter the first channel and having an air outlet for allowing air from the first chamber to freely flow from the first storage chamber to the second storage chamber when the air pressure in the first storage chamber is greater then the air pressure in the second storage chamber;
a second channel having a second air inlet in the second storage chamber for allowing air from the second storage chamber to enter the second channel and having a second air outlet for allowing air from the second chamber to freely flow from the second storage chamber to the first storage chamber when the air pressure in the second storage chamber is greater than the air pressure in the first storage chamber whereby the air pressure in the first and second storage chambers is maintained at the same level;
the first and second upper portions adapted for receiving the first and second liquids respectively when the device is rotated from its upright position up to ninety degrees about a horizontal axis, with the first and second air inlets remaining above the first and second liquids during the rotation;
means for mixing the liquid from the first storage chamber and the second storage chamber; and
means for expelling the mixed liquid.

19. The device of claim 18 and further comprising:
means associated with the second channel for preventing liquid from flowing from the first storage chamber to the second storage chamber; and
means associated with the first channel for preventing liquid from flowing from the second storage chamber to the first storage chamber.

20. The device of claim 17 and further comprising means for applying a positive air pressure to either the first storage chamber or the second storage chamber.

21. The device of claim 18 wherein the means for mixing the liquid comprises a mixing chamber adapted to accept liquid from the first storage chamber and the second storage chamber, the liquid flowing from the first storage chamber to the mixing chamber through the first liquid delivery tube and from the second storage chamber to the mixing chamber through the second liquid delivery tube.

22. The device of claim 19 wherein the means associated with the first and second channels for preventing liquid from flowing to the other chamber is an umbrella valve mounted in each of the first channel and the second channel.

23. The device of claim 18 and further comprising means for restricting liquid flow to the mixing chamber from either the first or the second storage chamber.

24. The device of claim 18 wherein the means for expelling liquids further comprises a piston, the piston having an open position and a closed position, the piston sealing flow from the mixing chamber through a liquid expulsion member when in the closed position.
